(19) United States
(12) Patent Application Publication
(10) Pub. No.: US 2010/0201730 A1
(43) Pub. Date: Aug. 12, 2010

(54) IMAGE FORMING APPARATUS, IMAGE FORMING METHOD, AND HEAD DEVICE

(75) Inventor: Kenichi Satake, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/692,156

(22) Filed: Jan. 22, 2010

(30) Foreign Application Priority Data
Feb. 10, 2009 (JP) 2009-028365

(51) Int. Cl. B41J 29/38

(52) U.S. Cl. 347/12

(57) ABSTRACT

An image forming apparatus may include a head having: nozzles which eject ink for one pixel onto a recording medium; pressurization chambers coupled to the nozzles, and a pressure application portion. The pressure application portion may execute an ejection operation and/or a swinging operation. The ejection operation may include ejecting the ink from the nozzles. The swinging operation may enable swinging of meniscus of the ink in the nozzles and disable ink ejection. In some embodiments, a print control portion may control the ejection operation in the pressure application portion, and a swing control device may control the swing operation. In some embodiments, the swing operation may be directed at specific nozzles based upon image data scheduled to be printed.

### INCORPORATION BY REFERENCE

This application is based upon and claims the benefit of priority from the corresponding Japanese Patent application No. 2009-28365, filed Feb. 10, 2009, the entire content of which is incorporated herein by reference.

### FIELD OF THE INVENTION

The present invention relates to an image forming apparatus, an image forming method, and a head device, of an ink-jet system, for printing images by ejecting ink.

### BACKGROUND OF THE INVENTION

In an image forming apparatus, when the ejection of ink stops ink droplets may remain in a nozzle and/or head of ink-jet system. Components in the ink may evaporate after ejection of the ink stops. For example, a dispersant may evaporate, thereby increasing the viscosity of the ink. When the viscosity of the ink increases, the ink droplets may be not ejected and/or images may be distorted in any subsequent printing.

In order to solve this problem, the conventional proposal has been to use a technique of swinging a meniscus of ink to an extent such that no ink droplets are ejected.

Further, the events described below may be the cause of the ink ejection failure. When ink is in a stationary state, a layer in which the viscosity has increased is formed on a contact face with the atmosphere. This increase in viscosity may be due to the evaporation of a dispersant. Conventionally, an attempt has been made to eject ink droplets while this layer is diffused by swinging the meniscus. However, when the layer is thus diffused a concentration of the dispersant in the ink in the vicinity of the contact face with the atmosphere increases. (Namely, a concentration of a dispersoid lowers). Afterwards, from this contact face, the dispersant further evaporates, and a layer with an increased viscosity is newly formed. In the conventional technique, the increase of the viscosity and the accelerated evaporation of the dispersant due to the swinging are thus repeated, and as a result, in spite of the fact that the meniscus has been swung, the viscosity of the ink in a nozzle increases, and an ink droplet ejection failure occurs.

The present invention is based in part on a new finding that even if swinging of meniscus is performed, ink ejection failure occurs.

### SUMMARY OF THE INVENTION

The present invention aims to provide a new technique which is capable of preventing an ink droplet ejection failure.

In an embodiment, an image forming apparatus may include a head, a print control portion, and a swing control device. In some embodiments, the head may include a plurality of nozzles, a plurality of pressurization chambers, and/or a pressure application portion. An embodiment may include nozzles which eject ink for one pixel onto a recording medium. In some embodiments, a pressurization chamber may be connected to a nozzle. For example, a pressurization chamber may be in fluid communication with a nozzle, and accommodate ink therein. In some embodiments, the pressure application portion may execute an ejection operation and/or a swinging operation. In an embodiment, the ejection operation executed by the pressure application portion may include ejecting the ink from the nozzles. For example, the ejection operation may include applying a pressure to the ink stored in one of the pressurization chambers. In some embodiments, swinging the meniscus may refer to mixing one or more layers of ink at and/or near a contact face of the ink. For example, in various embodiments swinging a meniscus may include mixing one or more layers of ink to more evenly distribute viscous layers of ink at the contact face.

In an embodiment of an image forming apparatus, a print control portion may control the ejection operation in the pressure application portion; and a swing control device may control the swing operation in the pressure application portion. In some embodiments, the swing operation may include forming a meniscus on a first nozzle used upon printing of image data to be scheduled to be first printed after the swing operation is enabled to swing before ink is ejected from the first nozzle upon the printing of the image data, and is disabled to swing meniscus of a second nozzle which is not used upon the printing of the image data.

An embodiment of an image forming method a may include an ejection step of ejecting ink for one pixel onto recording medium by a plurality of nozzles; a pressure application step of executing an ejection operation of ejecting the ink from the nozzles by applying a pressure to the ink stored in a respective one of the pressurization chambers and a swinging operation of enabling swinging of meniscus of the ink in the nozzles, whereas disabling ink ejection, in a plurality of pressurization chambers connected with the nozzles, respectively, and accommodate ink therein; a print control step of controlling the ejection operation in the pressure application step; and a swing control step of controlling the swing operation in the pressure application step, wherein: in the swing operation, among the plurality of nozzles, meniscus of a first nozzle used upon printing of image data to be scheduled to be first printed after the swing operation is enabled to swing before ink is ejected from the first nozzle upon the printing of the image data, and is disabled to swing meniscus of a second nozzle which is not used upon the printing of the image data.

A head device according to another aspect of the present invention includes: a plurality of nozzles which eject ink for one pixel onto recording medium; a plurality of pressurization chambers connected with the nozzles, respectively, and accommodate ink therein; and a pressure application portion for executing an ejection operation of ejecting the ink from the nozzles by applying a pressure to the ink stored in a respective one of the pressurization chambers and a swinging operation of enabling swinging of meniscus of the ink in the nozzles, whereas disabling ink ejection, wherein: in the swing operation, among the plurality of nozzles, meniscus of a first nozzle used upon printing of image data to be scheduled to be first printed after the swing operation is enabled to swing before ink is ejected from the first nozzle upon the printing of the image data, and is disabled to swing meniscus of a second nozzle which is not used upon the printing of the image data.

The above and other objects, features, and advantages of the present invention will be more apparent from the following detailed description of embodiments taken in conjunction with the accompanying drawings.

In this text, the terms “comprising”, “comprise”, “comprises” and other forms of “comprise” can have the meaning ascribed to these terms in U.S. patent Law and can mean “including”, “include”, “includes” and other forms of “include”.

Various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a schematic front view showing a construction of an ink-jet printer 1 according to a first aspect of the present invention;

FIG. 2 is a plan view of an ink ejection face 23 of a head 21 of the ink-jet printer 1 according to the first aspect of the present invention;

FIG. 3 is a sectional view seen in the direction of the arrow A-A, of the print head 21 of the ink-jet printer 1 according to the first embodiment of the present invention;

FIG. 4 is a block diagram showing a construction of essential parts of a head drive portion 210 and a control device 10 of the ink-jet printer 1 according to the first embodiment of the present invention;

FIG. 5 is a flowchart showing a flow of image data analysis of the ink-jet printer 1 according to the first embodiment of the present invention;

FIG. 6 is a flowchart showing a flow of swing control of the ink-jet printer 1 according to the first embodiment of the present invention;

FIG. 7 is a view schematically showing an example of a signal to be input to the head 21 of the ink jet printer 1 according to the first embodiment of the present invention;

FIG. 8 is a view schematically showing an example of a signal to be input to the head 21 of the ink-jet printer 1 according to the first embodiment of the present invention;

FIG. 9 is a block diagram showing a construction of essential parts of a head drive portion 210 and a control device 101 of an ink-jet printer 100 according to a second embodiment of the present invention;

FIG. 10 is a flowchart schematically showing an example of image data processing of the ink-jet printer 100 according to the second embodiment of the present invention;

FIG. 11 is a view schematically showing an example of a signal to be input to the head 21 in the ink-jet printer 100 according to the second embodiment of the present invention; and

FIG. 12 is a view schematically showing a signal to be input to a head in a comparative example.

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents. Preferred embodiments of image forming apparatus, image forming method, and head device of the present invention will now be described in detail according to constitutional features.

Referring to the drawings, an ink-jet printer 1 according to one embodiment will be described below.

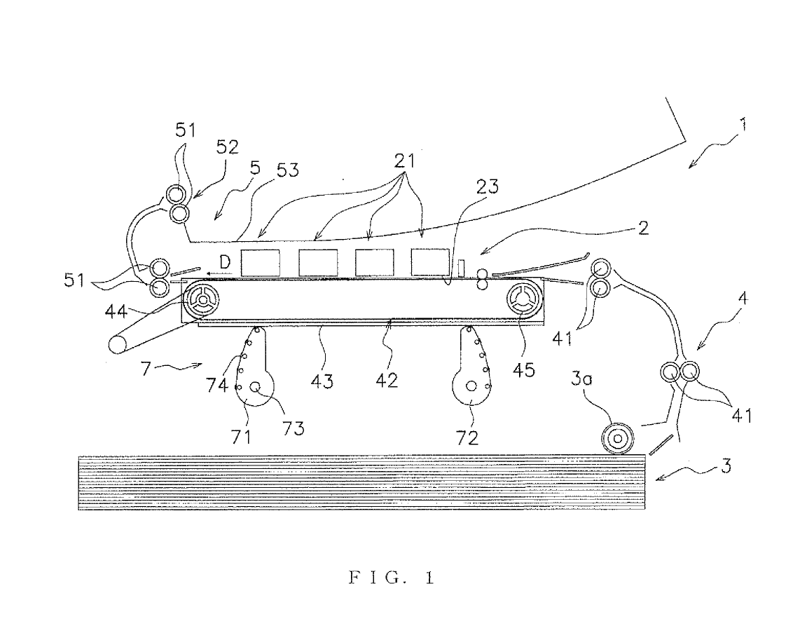

FIG. 1 is a schematic front view schematically showing a configuration of ink-jet printer 1. FIG. 1 depicts a configuration of essential parts of ink-jet printer.

Ink-jet printer 1 is provided as one example of an image forming apparatus. Ink jet printer 1 may include image forming portion 2; paper storage portion 3; paper transfer portion 4; ejection portion 5; and elevation device 7, as shown in FIG. 1. The inks used in ink-jet printer 1 are obtained by dispersing pigments coated with a resin on their surface, as a dispersoid, in a dispersant. In some embodiments, the dispersant may include water. In an embodiment, the dispersant may consist essentially of water.

Image forming portion 2 forms images, based upon image information, and is shown in FIG. 1 with four heads 21. In some embodiments, a number of heads in the image forming portion may vary.

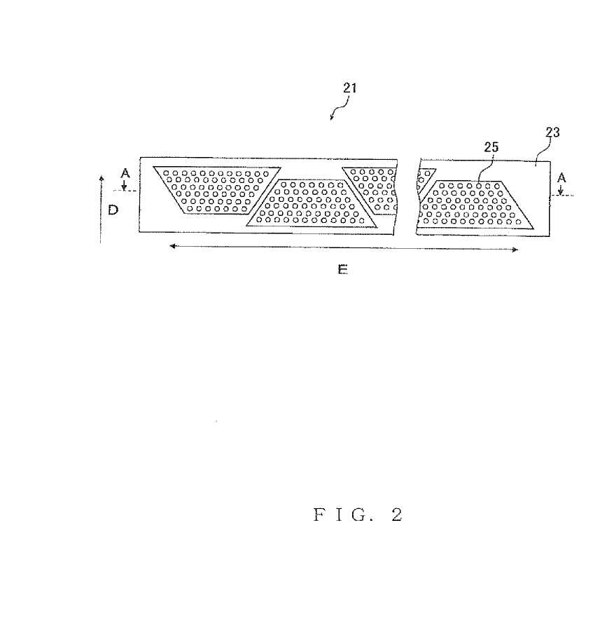

As shown in FIG. 1, each of the four heads 21 is provided with ink ejection face 23, and is disposed in juxtaposition therewith along a paper transfer direction of paper transfer portion 4 upward of paper transfer belt 42 of paper transfer portion 4. Each of these heads 21 is disposed with ink ejection face 23 being oriented toward paper transfer portion 4. Heads 21 store inks of different colors. In some embodiments, the heads may eject the stored inks. In some embodiments, the heads may eject the stored ink according to the image data transmitted from a host device. Thus, printing may occur according to the image data transmitted from a host device, although not shown. In some embodiments, the entire heads 21 are members extending in a unidirectional direction (the direction orthogonal to the paper face of FIG. 1 and the direction E indicated in FIG. 2 or the like), each of which is shaped like a substantially rectangular prism.

In some embodiments, paper storage portion 3 stores a sheet of paper which is provided as one example of recording media. In addition, paper storage portion 3 has supply roller 3a rotating upward at a tip end part of a paper supply side, thereby feeding out a sheet of paper to the paper transfer portion 4.

Paper transfer portion 4 is provided as one example of a recording media transfer portion. Paper transfer portion 4 may transfer the paper of paper storage portion 3 to image forming portion 2. Further, paper transfer portion 4 may transfer a sheet of paper to ejection portion 5. The sheet of paper transferred may include an image on a surface formed by image forming portion 2. Specifically, paper transfer portion 4 may include a plurality of transfer rollers 41; a transfer belt 42; a belt support member 43; and belt rollers 44, 45. Transfer roller 41 rotates, thereby transferring paper towards the left direction (direction D) of FIG. 1. Transfer belt 42 is a no-end belt, and is disposed below heads 21 with the belt being overhung on belt rollers 44, 45. As belt roller 44, transfer belt 42, and belt roller 45 rotate, a sheet of paper is thereby transferred. In some embodiments, belt roller 44 may be driven by a device including, but not limited to a drive motor, and/or any device known in the art, although not shown. In some embodiments, belt rollers 44, 45 are rotatably fixed to belt support member 43. Further, transfer belt 42 may be supported by belt support member 43, via belt rollers 44, 45.

In some embodiments, elevation device 7 is disposed below transfer belt 42, and may vertically elevate transfer belt 42. In some embodiments, elevation device 7 has a pair of eccentric cams 71, 72. Among the pair of eccentric cams 71, 72, eccentric cam 71 is positioned at the left side in FIG. 1 (hereinafter, referred to as “first eccentric cam 71”). First eccentric cam 71 may be positioned such that it rotates around a shaft portion 73. In some embodiments, the rotation of first eccentric cam 71 may be driven by a motor or any other means known in the art, although not shown. A plurality of bearings 74 may be provided in eccentric cam 71. In some embodiments, eccentric cam 71 may support belt support member 43 using bearing 74. In FIG. 1, only one bearing is noted with a symbol 74 while the others are omitted. In some embodiments, eccentric cam 72, may be positioned at the right side of ink-jet printer 1 as shown in FIG. 1 (hereinafter, referred to as “second eccentric cam 72”). In an embodiment, eccentric cams 71, 72 may have similar structures. For example, second eccentric cam 72 may be symmetrical to first eccentric cam 71 of FIG. 1. In an embodiment, transfer belt 42 may rise as is shown in FIG. 1. In this state, a pair of eccentric cams 71, 72 rotates inward, and transfer belt 42 thereby lowers. In elevation device 7, when an image is formed on a sheet of paper by image forming portion 2, with the transfer belt 42 being in a rising state shown in FIG. 1, a gap may exist between head 21 and the paper. This gap may be defined within a range of dimensions suitable for printing. For example, the gap may be in range of about 1 mm. In some embodiments, when a process associated with paper jamming on the transfer belt 42 is performed or when cleaning of the head 21 is performed by a cleaning device, transfer belt may be lowered. Thus, a gap between head 21 and the paper may widen.

In some embodiments, ejection portion 5 may eject a sheet of paper on which an image has been formed by the image forming portion 2. As shown in FIG. 1, ejection portion 5 is disposed at an upper part of ink-jet printer 1. Ejection portion 5 may include a plurality of rollers 51. The sheet of paper on which the image has been formed by image forming portion 2 may be transferred by transfer belt 42 of paper transfer portion 4 and rollers 51 of ejection portion 5. In some embodiments, the transferred sheet of paper is ejected from outlet 52 to paper ejection tray 53 which is arranged on a top face of ink-jet printer 1.

In some embodiments, an ink-jet printer may be provided with a cleaning device and a capping device, although not shown. In an embodiment, the cleaning device may be interposed between head 21 and transfer belt 42. An embodiment of the cleaning device may clean ink injection face 23 of head 21. For example, the cleaning device may clean the ink injection face when the transfer belt is lowered or being lowered. Some embodiments may include a capping device having a cap, and an attaching/detaching portion capable of attaching/detaching this cap to/from ink ejection face 23. In some embodiments, the capping device may protect the head by covering it. Thus, the capping device may inhibit or prevent a dispersant of ink from excessively evaporating from a nozzle when the printer is not being used.

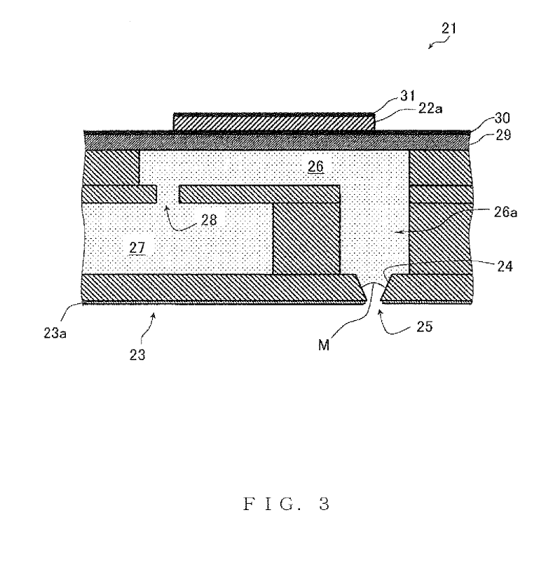

FIG. 2 is a plan view of ink ejection face 23 of head 21; and FIG. 3 shows a sectional view seen in the direction of the arrow A-A of head 21.

As shown in FIG. 2, a plurality of ejection openings 25 are provided on ejection face 23. Ejection openings may be openings of nozzles 24, each of which has a very small diameter. As shown in FIG. 2, ejection openings 25 are disposed on ejection face 23 in a staggered manner. In some embodiments, the ejection openings are positioned so that no blank space occurs between the adjacent pixels when ink droplets are ejected onto a sheet of paper. An embodiment may include arranging ejection openings 25 at least over a maximum width of paper in the vertical direction (direction E) of ejection face 23.

As shown in FIG. 3, an embodiment of head 21 may include water repellent film 23a, pressurization chambers 26, an ink tank for reserving ink (not shown), and a common flow path 27. In an embodiment, a water repellent film may cover a portion of the ejection face. For example, a water repellant film may cover the portion of the ejection face not having ejection openings. Some embodiments include pressurization chambers which are provided for ejection openings 25 on a one-by-one basis. In some embodiments, a common flow path for supplying ink from the ink tank to a plurality of pressurization chambers may be utilized. In some embodiments, the pressurization chamber and the common flow path may be in fluid communication. For example, pressurization chamber 26 and common flow path 27 may be connected to each other via supply hole 28. For example, ink may be supplied from common path 27 to pressurization chamber 26 via supply hole 28. As shown in FIG. 3, nozzle 24 and pressurization chamber 26 are in fluid communication through nozzle path 26a. In an embodiment, the pressurization chamber may include a vibration plate. As is shown in FIG. 3, pressurization chamber 26 includes vibration plate 29 on a wall opposite ejection face 23. In some embodiments, a vibration plate may be continuously formed across a plurality of pressurization chambers. In some embodiments, a common electrode 30 is continuously formed across the plurality of pressurization chambers 26. As is shown in FIG. 3, vibration plate 29 and common electrode 30 may be continuously formed across pressurization chamber 26. In some embodiments, the vibration plate and/or common electrode may extend such that one or both are continuously formed across a plurality of pressurization chambers. In some embodiments, a common electrode may be laminated. In an embodiment, where the common electrode extends continuously across a plurality of pressurization chambers, piezoelectric element 22a is provided for each of pressurization chambers 26, and an additional individual electrode 31 is provided for each of pressurization chamber 26 so as to sandwich piezoelectric element 22a together with the common electrode 30.

When ink is ejected on a sheet of paper from ejection opening 25 by applying an ejection signal, ink may be left in nozzle 24. Thus, the ink droplets which are not ejected may form a meniscus (face) M in nozzle 24.

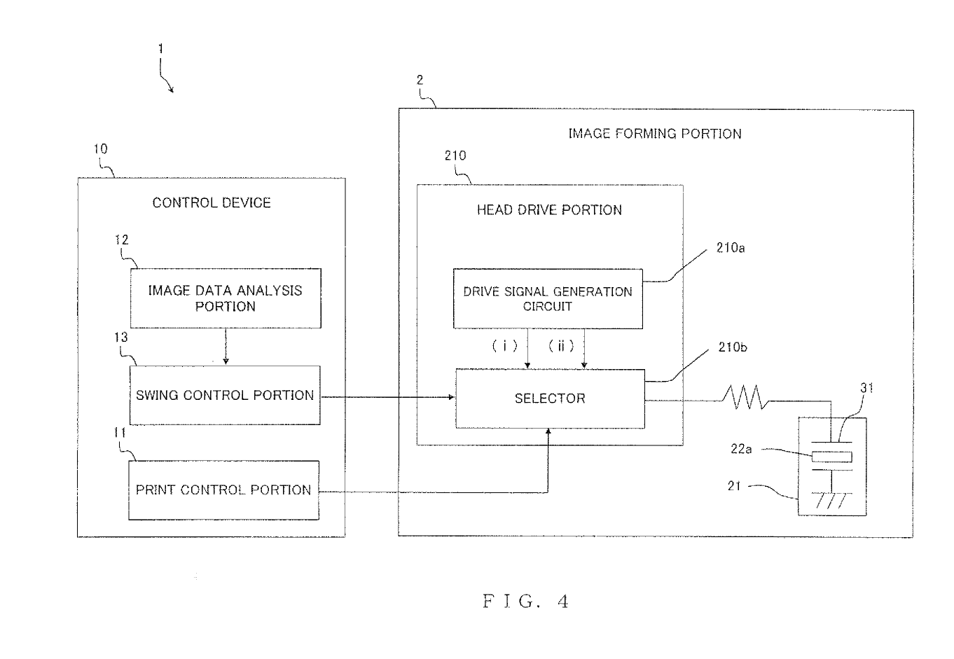

In some embodiments, an ink-jet printer may include a head drive portion and a control device. FIG. 4 is a block diagram showing a configuration of the essential parts of head drive portion 210 and control device 10.

As shown in FIG. 4, head drive portion 210 may include drive signal generation circuit 210a, and selector 210b. In some embodiments, a drive signal generation circuit may generate two kinds of drive pulses (i) and (ii). In an embodiment, a selector (e.g., selector 210b) may select either of the drive pulses (i) and (ii) according to control of the control device, and apply the selected pulse to piezoelectric element 22a of head 21 via a resistor and a capacitor or the like.

A waveform of the drive pulse (i) is set to ensure that a pressure to an extent such that ink droplets are to be ejected is applied to the pressurization chamber 26 via the piezoelectric element 22a. Specifically, the drive pulse (i) is comprised of one pulse. In some embodiments, the pulse width of the drive pulse may be pre-determined. For example, the length of the pulse width of the drive pulse (i) may be in a range from about 1 microsecond to about 20 microseconds. In an embodiment, the pulse width of the drive pulse (i) may have a length of about 7 microseconds). The length of the pulse width may be close to a half cycle of a specific vibration cycle of the head flow path. For example, a half cycle of a vibration cycle of the head flow path may be about 13 microseconds and a length of the pulse width of the drive pulse may be about 7 microseconds. A term “head flow path” used herein refers to nozzle 24, nozzle flow path 26a, pressurization chamber 26, and supply hole 28, as shown in FIG. 3. In some embodiments, the length of the pulse width of a drive voltage to be applied to piezoelectric element 22a, is close to half of the specific vibration cycle of the head flow path. According to such a drive voltage, an intra-nozzle flow rate exceeds 10 m/s, so that one ink droplet is ejected from ejection opening 25.

In some embodiments, the drive pulse (ii) may be set so that meniscus M is swung without ink droplet ejection. For example, drive pulse (ii) may be formed by repeating a pulse having a pulse width which is smaller than the pulses width of drive pulse (i) a plurality of times. In some embodiments, the pulse width of an individual pulse of drive pulse (i) may be set to be significantly shorter than the specific vibration cycle of the head flow path. Thus, in some embodiments, the pulse width of the drive voltage to be applied to the piezoelectric element 22a is shorter than the specific vibration cycle of the head flow path. When such a short pulse becomes continuous, the intra-nozzle flow path may be obtained. The intra-nozzle flow path may be established in a manner such that ejection of ink droplets is inhibited. In such embodiments, the meniscus M may be swung.

Hereinafter, the drive pulse (i) is referred to as an ejection signal and the drive pulse (ii) is referred to as a swing signal.

In some embodiments, movement of the head may be controlled by ejection signal (i) and swing signal (ii). In some embodiments, ejection signal (i) from head drive portion 210 may be applied to individual electrode 31, whereby piezoelectric elements 22a are individually driven. In some embodiments, a deformation of piezoelectric element 22a due to this driving is transmitted to vibration plate 29, and pressurization chamber 26 is compressed by the deformation of the vibration plate 29 for the configuration depicted in FIG. 3. As a result, a pressure is applied to the ink contained in pressurization chamber 26, and the ink having passed through nozzle 24 is ejected onto a sheet of paper, as ink droplets from ejection opening 25. In this way, the ink droplets are deposited onto the paper and paper transfer portion 4 moves the paper, so that ink droplets are ejected one after another onto a blank sheet of paper. As a result, an image is printed all over one sheet of paper. In some embodiments, supply roller 3a is rotated at predetermined intervals, and sheets of paper are thereby transferred one after another at predetermined intervals, and images are sequentially printed on the sheets of paper.

In an embodiment, applying swing signal (ii) to individual electrode 31, compresses pressurization chamber 26, whereby the meniscus M swings, and no ink droplets are ejected.

In an embodiment, the number of gradations is set to “2” for the convenience of explanation. For example, ejection of ink droplets from the nozzle is switched to either of two states of ejection and non-ejection, respectively, depending upon applying and non-applying of the ejection signal (i). In actual equipment, however, in a case where an image with gradation number N is formed, the drive signal generation circuit 210a can generates ejection signals (i1), (i2), (i3), . . . (i(N−1)) of (N−1) types, which are responsive to gradation values or have different numbers of pulses, and the selector 210b may be adapted to select either of these multiple ejection signals. In this case as well, there is no need to apply an ejection signal in zero-gradation in which no printing is performed.

In some embodiments, a control device may include a CPU, a ROM, and a RAM. A control device, such as control device 10 depicted in FIG. 4 may control operation of ink-jet printer 1 and of head drive portion 210.

In an embodiment, as shown in FIG. 4, control device 10 is provided with print control portion 11; image data analysis portion 12; and swing control portion 13. As disclosed herein, a term “image data” refers to secondary “image data” suitable for printing control in a ink-jet printer. Secondary image data may be obtained by processing primary “image data”. Data obtained from an external device, such as a scanner, is referred to as primary image data. For example, by executing UCR (Under Color Removal), color-matching, and gamma correction to the “primary image data”, 256 gradation image data is obtained. And by executing dithering and changing the number of gradation to the 256 gradation image data, “secondary image data” is obtained. The following description designates print data (e.g., secondary image data) having a predetermined number of gradations, and generated in a print data generation portion (not shown) included in the control device 10, based upon the primary image data.

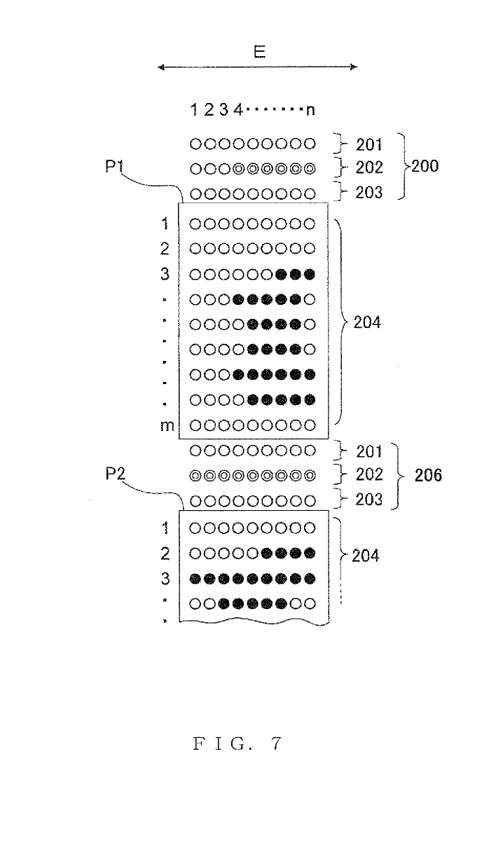

In some embodiments, print control portion 11 controls selector 210b based upon image data. Hereinafter, print control will be described referring to FIG. 7.

FIG. 7 is a schematic view showing an example of a signal to be input to the head. Further, the figure may be regarded as a drawing schematically showing pixels. In FIG. 7, P1 and P2 indicate pages targeted to be printed. As shown in FIG. 7, the components in a horizontal direction, namely the components in line designate the pixels in a main scanning direction, and the components in a vertical direction, namely the components in column designate the pixels in a sub scanning direction. Further, in FIG. 7, the components in the first to n-th columns designate the pixels corresponding to the same nozzle 24. Namely, one nozzle corresponds to the pixels on a sheet of paper from the first to m-th lines of the second column, for example, another nozzle corresponds to the pixels on a sheet of paper on the first to m-th lines of the n-th column, for example.

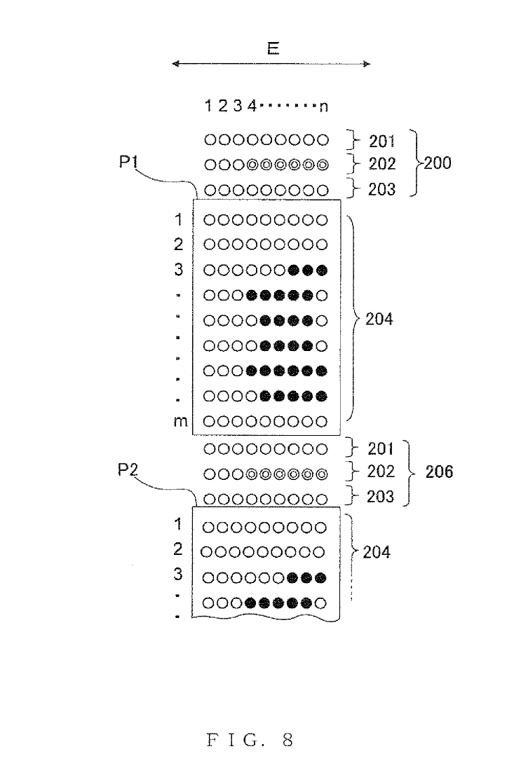

As shown in FIG. 7 and FIG. 8, the pixels are simplified. In an actual printer, very small pixels are numerously printed, and a resolution of horizontal 4800 dpi and vertical 1200 dpi, for example, can be thereby realized.

Pixels to be printed are indicated by the black circles () in FIG. 7. Print control portion 11 (shown in FIG. 4) controls selector 210b (shown in FIG. 4) to apply the ejection signal (i) to individual electrode 31 (shown in FIG. 3) so that ink droplets are ejected with respect to nozzles 24 (shown in FIG. 3) corresponding to the pixels indicated by the black circles.

Pixels to be blanked without printing are indicated by the white circles (◯) in FIG. 7. In an embodiment, the print control portion controls the selector such that neither the ejection signal nor the swing signal is applied to the individual electrode for pixels represented by white circles. By not applying a signal, ink will not be ejected. For example, the print control portion controls the selector such that neither the ejection signal (i) nor the swing signal (ii) is applied to the individual electrode 31. Thus, no ink droplets are ejected with respect to the nozzles 24 corresponding to the pixels indicated by the while circles.

In some embodiments, the print control portion performs a control operation only when printing is in progress. A term “printing” used herein refers to a period during which the signals corresponding to the white circles or the black circles in a print region 204 such as pages P1 and P2 are applied from the head drive portion to the head as shown in FIG. 7. Namely, the term “printing” may mean a period during which a sheet of paper is set in a printable position by head 21. In other words, even while in “printing”, individual nozzles 24 may be either ejecting ink droplets or not. While, in the specification, a term “non-printing” is also used as an antonym for “printing”, a further description thereof will be described later.

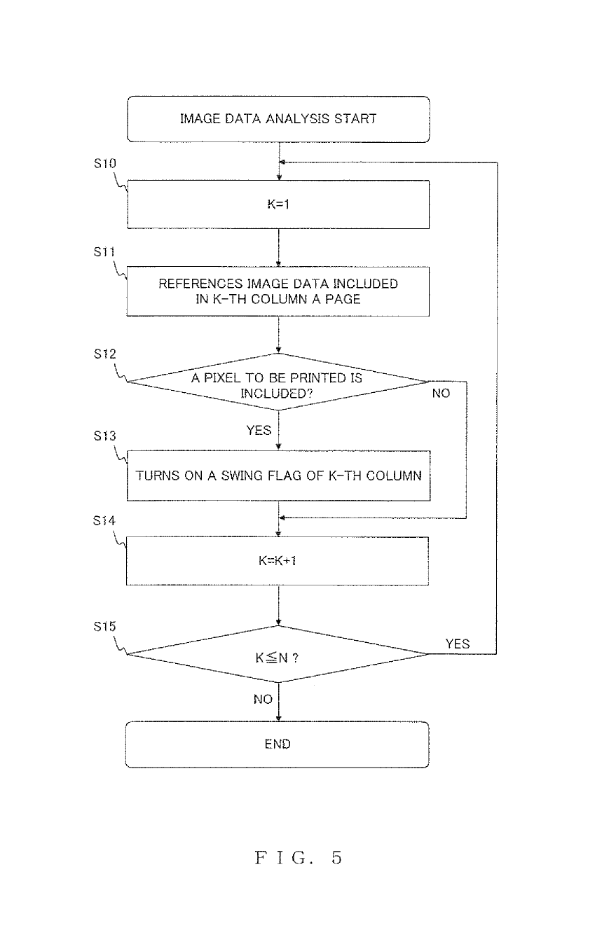

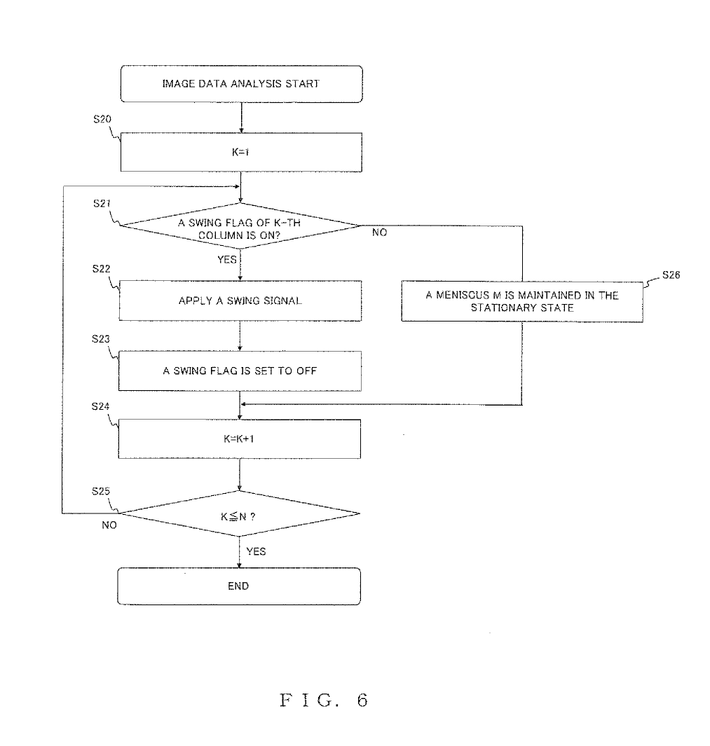

Swing control will be described referring to FIGS. 4 to 7. FIG. 5 is a flowchart showing a flow of image data analysis, and FIG. 6 is a flowchart showing a flow of swing control.

As shown in FIGS. 4 and 5, image data analysis portion 12 references image data included in the first column on page 1 shown on FIG. 7. In some embodiments, image data analysis portion 12 may include steps S10 and S11 of FIG. 5. If a pixel to be printed is included in the first column (“Yes” at step S12), the image data analysis portion 12 turns ON the swing flag of the first column with respect to a reference page (step S13). On the other hand, if a pixel to be printed is not included in the first column (“No” at step S12), the swing flag is maintained to be OFF. This process is executed with respect to all columns (the first to n-th columns shown in FIG. 7) as shown in steps S14 and S15 of FIG. 5. Thus, image data is analyzed for the whole page. In addition, similar processing may be performed for all of the pages to be printed. In some embodiments, the ON/OFF setting of the swing flag may be maintained in memory (not shown) included in the image data analysis portion 12.

Referring to an example depicted in FIG. 7, the ON/OFF setting of the swing flag will be specifically described. As shown in FIG. 7, in a case where an image is formed across a plurality of pages P1 and P2, the image data analysis portion 12 references image data of page P1, prior to printing page P1. As shown in FIG. 7, a pixel to be printed (black circle) is not included in the first column of page P1 (the first to m-th lines of the first column). In this case, the image data analysis portion 12 maintains the swing flag of the first column to be set to OFF with respect to page P1. With respect to the second and third columns as well, the swing flag is set to OFF similarly. On the other hand, the pixels to be printed (black circles) are included in the fourth to n-th columns, so that with respect to these columns, the image data analysis portion 12 sets the swing flags to ON, respectively.

In an embodiment, the image data analysis portion 12 references image data of page P2 prior to printing page P2. In the image data of page 2 that follows page P1, the pixels to be printed (black circles) are included in all of the columns. Therefore, the image data analysis portion 12 sets the swing flag of a respective one of the first to n-th columns to ON with respect to page P2.

In an embodiment, as shown in FIG. 4 swing control portion 13 controls operation of selector 210b while in non-printing. A term “non-printing” used here designates a non-printing period, a so called “paper interleaving”. As shown in FIG. 7, the term “paper interleaving” may refer to paper interleaving 200 and/or paper interleaving 206. Paper interleaving 200 designates a period between determination of image data to be printed and feeding of a first sheet of paper. While paper interleaving 206 designates a period between the completion of printing of one sheet of paper and the start of printing of a next sheet of paper in a case where printing is continuously performed across a plurality of sheets of paper. The above wording “determination of image data to be printed” designates that a user has made a print request of the specified image data to be printed, via an operating panel or an external device, although not shown.

As shown in FIG. 6, swing control portion 13 references a swing flag corresponding to a page to be printed immediately, among the swing flags set relative to columns during non-printing (steps S20 to S21 and steps S24 to S25). As shown in FIG. 4, swing control portion 13 controls selector 210b so as to apply swing signal (ii) to individual electrode 31 corresponding to nozzle 24 (shown in FIG. 3) in a column in which the swing flag is set to ON (“Yes” at step S21->S22 of FIG. 6). As a result, meniscus M is swung in this nozzle 24. Afterwards, a swing flag set to ON is set to OFF (step S23). When a swing flag is set to OFF in a column, neither the ejection signal (i) nor the swing signal (ii) is applied to individual electrode 31 corresponding to nozzle 24, and the meniscus M of this nozzle 24 is maintained in a stationary state (step S26).

Referring now to an example of FIG. 7, swing control will be specifically described. In FIG. 7, paper interleaving region 200 is depicted above page P1. These paper interleaving regions 200, 206 are each divided into three regions, i.e., a first blank region 201, a swing region 202, and a second blank region 203. First blank region 201 is a region which is the furthest from print region 204; second blank region 203 is a region including an immediately preceding line of the first line of print region 204, and swing region 202 is a region between first blank region 201 and second blank region 203.

In FIG. 7, although the first blank region 201, the swing region 202, and the second blank region 203 are drawn as one line for the convenience of explanation, in practice a plurality of lines may be included. With respect to the length of each region, the lengths of each region may vary in some embodiments. In an embodiment, the blank regions and the swing region may all have different lengths. For example, in some embodiments the length in the sub scanning direction of the paper interleaving regions 200, 206 can be set to be on the order of 2,800 lines, with first blank region 201 having a length on the order of 1,300 lines; with swing region 202 having a length on the order of 1,000 lines; and with second blank region 203 having a length on the order of 500 lines.

As indicated by the white circles (◯) in FIG. 7, swing control portion 13 maintains a stationary state of meniscus M in first blank region 201 and second blank region 203, and performs control operation according to the swing flag in swing region 202.

As described above, in the example of FIG. 7, the swing flags of the first to third columns are set to OFF with respect to page P1. For the 4^{th} to nth columns of P1, the swing flags are set to ON as shown in FIG. 7. Therefore, as shown in FIG. 7, in swing region 202 of interleaving region 200, swing control portion 13 maintains the meniscus M in a stationary state with respect to nozzles 24 (shown in FIG. 3) of the first to third columns (white circles), and swings the meniscus M with respect to nozzles 24 of the fourth to n-th columns (double circles ( [symbol] )).

As shown in FIG. 7, the swing flags are set to ON with respect to all of the first to n-th columns for page P2, so that swing control portion 13 swings the meniscus M of the nozzles 24 of the first to n-th columns in the swing region 202 of interleaving region 206 (double circles ( [symbol] )).

In the nozzles of the first to third columns, which are not employed for printing of page P1, the meniscus M of ink is thus maintained in a stationary state prior to the printing of page P1. This may inhibit or prevent a print failure in the pixels in which printing is first performed on page P2 (the pixels of the third lines of the first to third columns in FIG. 7), among the pixels of the first to third columns. This may occur because swinging is not performed prior to the printing of page P1, whereby a layer with a high concentration of a dispersoid, which is generated near the meniscus M of the nozzle 24, inhibits evaporation of the dispersant from the ink in the nozzles of the first to third columns while in printing of page P1. Although the meniscus M in the nozzles of the first to third columns is not swung prior to the printing of page P1, it is swung prior to the printing of page P2; and therefore, in the printing of page P2, faulty ejection of ink droplets or image distortion due to an excessive increase of viscosity of ink may be inhibited. In some cases, faulty ejection of ink droplets or image distortion may be prevented.

As described above, in an embodiment, image data analysis portion 12 and swing control portion 13 (shown in FIG. 4) serve as one example of a swing control device. For example, image data analysis portion 12 and swing control portion 13, swing the Meniscus M in a nozzle (first nozzle) which is used to print image data to be first printed, and maintain the meniscus M of a nozzle (second nozzle) not to be used in a stationary state.

In some embodiments, the image data may be analyzed prior to executing printing of each page. A timing of executing analysis may vary in some embodiments. For example, the timing of executing analysis may fall within a range. Some embodiments may include executing analysis of the image data in time frame sufficient to allow swing control to be performed. In some embodiments, this timing of analysis can also be varied depending upon the size of the memory included in the image data analysis portion.

For example, in some embodiments the memory of image data analysis portion 12 may be sufficient to maintain swing flags for 10 pages. In this case, if a request is made to print image data for 10 pages, each page having image data different from each other, the image data analysis portion 12 can analyze the image data for all pages prior to the start of printing; set swing flags for each page; and store the settings. Afterwards, swing control portion 13 may perform swing control, referring to the swing flags, in the immediately preceding swing region 202 of each page.

In addition, image data analysis portion 12 may hold the swing flags of images for the next two pages, for example. In this case, when the image data for 10 pages is printed, image data analysis portion 12 may perform analysis for the next two pages and swing flag settings. In some embodiments, there may be no need to hold the swing flags for the two pages, after performing analysis of the two pages and setting the swing flags along the printing sequences and completing swing control using the swing flags.

Further, in a case where multiple copies of an identical image are printed, the image data analysis portion 12 may perform swing control as to a plurality of pages, by employing an analysis result obtained as to one item of image data. As shown in FIG. 8, in a case where identical image data is continuously printed on pages P1 an P2, in accordance with upon the swing flags set by the image data analysis portion 12 based upon the image data, the swing control portion 13 may allow the immediately preceding swing pattern of the first page P1 and that of the next page P2 to be treated as an identical pattern.

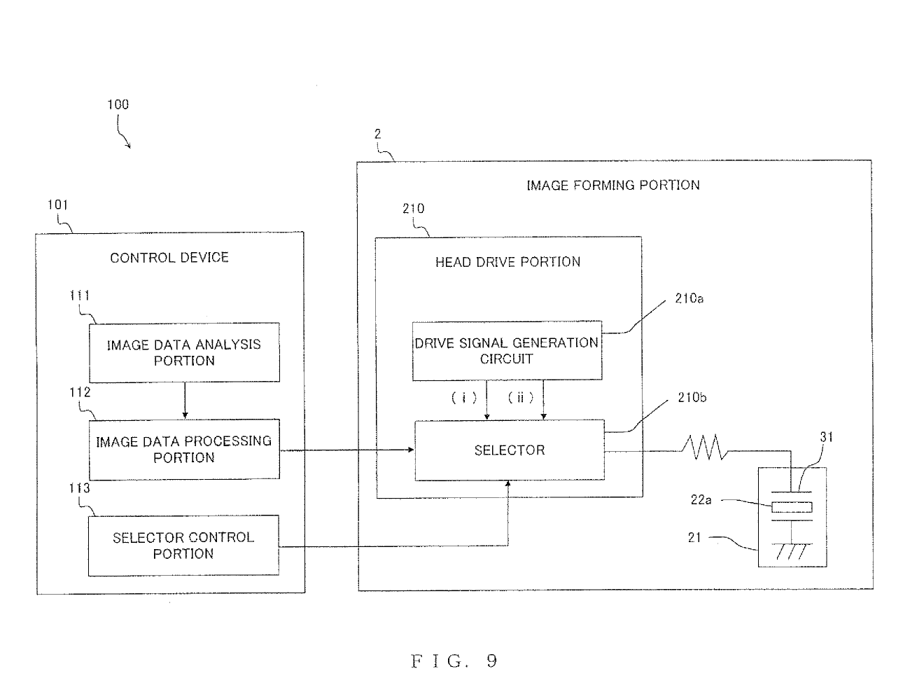

In an embodiment, an ink-jet printer 100 may be configured in a manner similar to ink jet printer 1 described herein. Some embodiments may include control device 101 is provided in place of control device 10 as shown in FIG. 9.

A block diagram of inkjet printer 100 is shown in FIG. 9. As shown in FIG. 9, control device 101 of inkjet printer 100 may include image data analysis portion 111, image data processing portion 112, and/or selector control portion 113.

Similar to image data analysis portion 12 (shown in FIG. 4), image data analysis portion 111 (shown in FIG. 9) may analyze image data targeted for printing, and sets swing flags for pixel columns of pages (shown in FIG. 5).

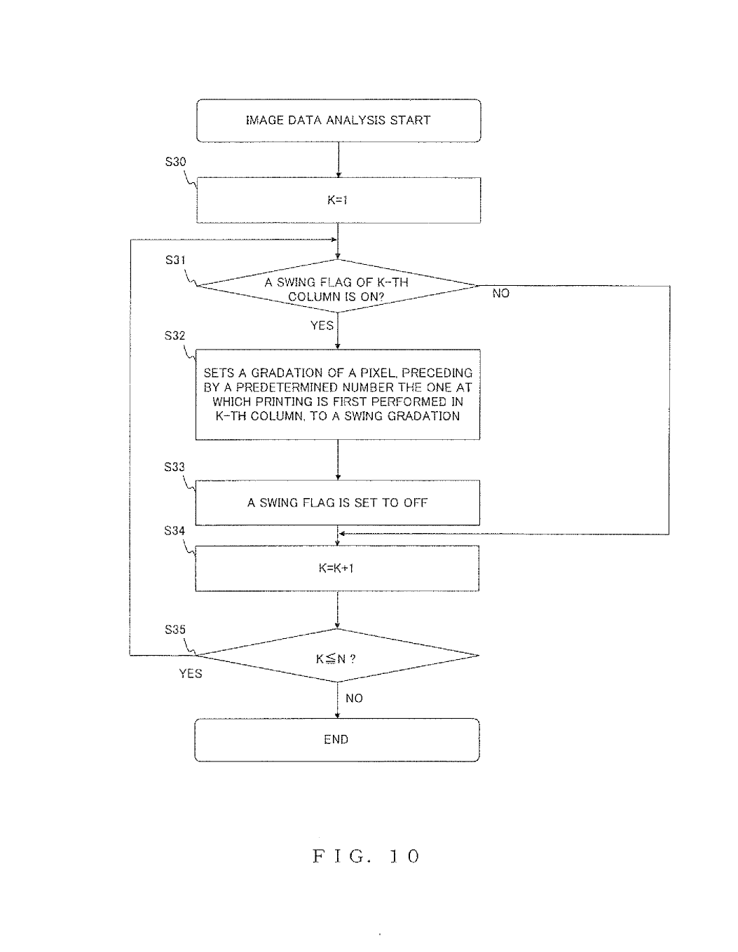

FIG. 10 is a flowchart depicting the processing of image data processing portion 112.

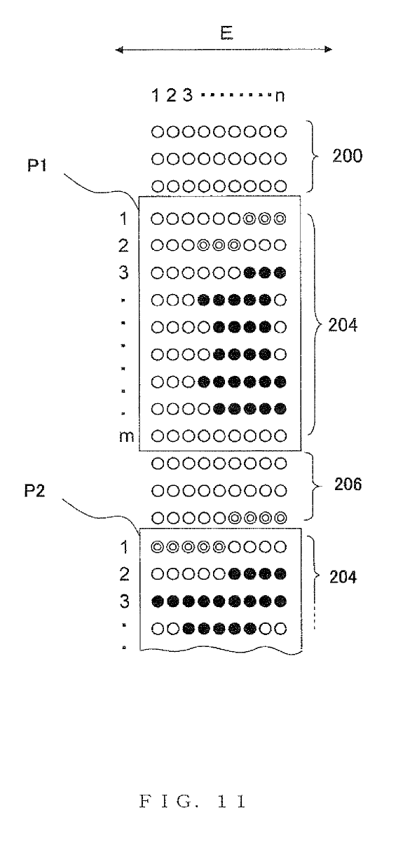

As shown in FIG. 10, a swing flag corresponding to a page to be printed immediately is referenced from among the swing flags set for columns (steps S30 and 31 and S34 and S35). If the swing flag is set to ON, image data processing portion 112 sets a gradation of a pixel, preceding by a predetermined number the one at which printing is first performed in the column, to a swing gradation to be described below, as indicated by double circles ( [symbol] ) in print region 204 of FIG. 11 (step S32).

That is, the swing gradation is an (N+1)-th gradation if the number of gradations of image data is N, for example, and is not included in any of ordinary gradations. In the pixel of a gradation signal, selector control portion 113 allows selector 210b to select a swing signal (ii).

In addition, “the predetermined number” of step S32 refers to setting the pixel of a swing gradation to a numerical value such that swinging does not affect ejection of ink relative to the pixel to be printed on a page targeted for the processing shown in FIG. 10. Specifically, the predetermined number may be set to 1 or more and to a value equal to or less than the number of lines (length) in a paper interleaving region 200 or 206 immediately preceding the above targeted page, more specifically is set to 200 or more and ¼ or less of the number of lines in a paper interleaving region 200 or 206.

When a swing gradation is set, a swing flag relative to the associated column is set to OFF (step S33).

The above processing is performed as to all of the columns of image data for one page (steps S34 and S35). By this processing, processed image data is generated with a swing gradation being added to source image data.

As shown in FIG. 9, selector control portion 113 controls selector 210b, based upon the processed image data. In other words, as to the pixel for ordinary gradation in the processed image data, selector 210b may select an ejection signal (i) in a pixel to be printed, or deselect either of the ejection signal (i) and the swing signal (ii) in a pixel in which no printing is performed, thereby disabling ink ejection or swinging, in response to the gradation value. In addition, as to the pixel of the swing gradation, as described above, the selector 210b selects the swing signal (ii) to swing meniscus M.

A specific example is shown in FIG. 11. FIG. 11 is a view schematically showing processed image data, based upon image data identical to that on pages P1 and P2 of FIG. 7. In FIG. 11, “a predetermined number” found in step S32 is set to “2” for the convenience of explanation.

As shown in FIG. 11, in those preceding print pixels () of pages, the meniscus M of nozzles from which these print pixels are to be printed is swung ( [symbol] )). In some embodiments, the swing gradation set based upon image data of a following page is disposed after the print region 204 of the preceding page. In some embodiments, the swing gradation set may be disposed in multiple regions. For example, as shown in FIG. 11, the swing gradation set based upon the image data of page P2 is disposed in a print region 204 of page P2 and in a paper interleaving region 206 between page P2 and page P1. In some embodiments, the swing gradation may be disposed in interleaving region 206 or print region 204.

In an embodiment, each of functional portions 111 to 113 of control device 101 serves as a swing control device, and selector control portion 113 serves as a print control portion.

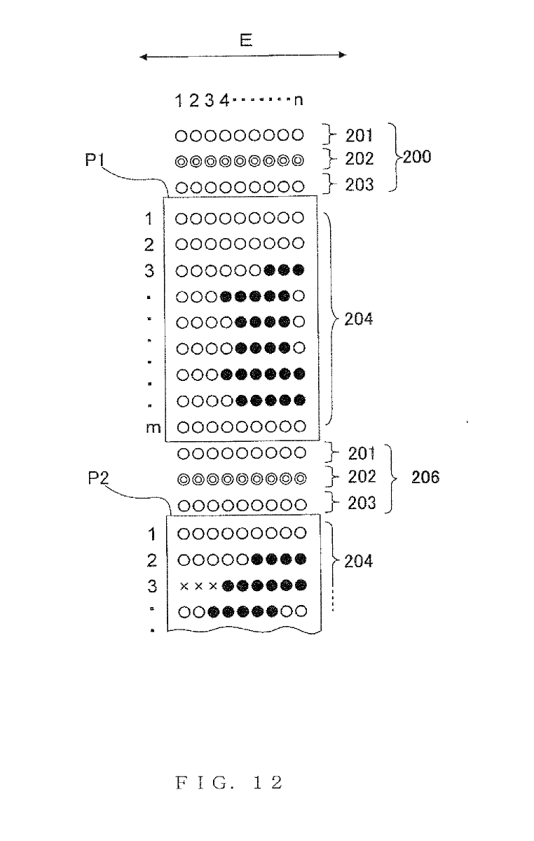

A schematic view of an input signal for a head utilizing technology known in the art is shown in FIG. 12. As shown in FIG. 12, the meniscus M in all of the nozzles is swung in the swing region 202, irrespective of the location of the image data to be printed after swinging.

In this case, as indicated by the crosses (x) on page P2 of FIG. 12, a print failure may occur in columns (the first to third columns) to be printed on page P2 which were not printed on page P1.

This may occur because a layer in which the concentration of a dispersoid has risen in the vicinity of the meniscus M is dispersed. This dispersal may occur due to the swinging which preceded page P1, whereby a dispersant of ink while in a stationary state has been accelerated without performing ink ejection in the print region 204 of page P1.

In some embodiments described herein, “image data for one page” can be understood as a synonym for “image data to be printed for one sheet of paper.” In an embodiment, a plurality of pages may be printed on one sheet of paper (e.g., 2-in-1), and thus a plurality of pages to be printed in one sheet of paper can be regarded as “one page” altogether.

However, the present invention is not limitative thereto, and a plurality of pages to be printed on one sheet of paper may be processed as image data, items of which are independent of each other. In general, in a case where a plurality of pages are printed on one sheet of paper, a blank region is provided in a paper transfer direction D between pages. Therefore, in some embodiments, this blank region being may be regarded as the abovementioned paper interleaving region 200, 206, processing which is similar to those described herein.

In some embodiments, a head drive portion, a common electrode, an individual electrode, and a piezoelectric element may serve as a pressure application portion for ejecting ink and swinging meniscus M. As shown in FIG. 3, head drive portion 210, common electrode 30, individual electrode 31, and piezoelectric element 22a may serve as a pressure application portion for ejecting ink and swinging meniscus M. The pressure application portion may be deemed as a synonym for providing a first pressure application portion for ejecting ink and a second pressure application portion for swinging meniscus M. In some embodiments, each of pressure application portions, specifically, the first pressure application portion and the second pressure application portion may have their own specific electrodes (e.g., common electrode and/or individual electrodes), piezoelectric elements, etc., respectively.

As shown in FIG. 7, swing region 202 of meniscus M is provided for each item of image data for one page, preceding such one page. As shown in FIG. 4, image data analysis portion 12 and swing control portion 13 allow the meniscus M of the nozzles (the fourth to n-th columns) used for printing image data to be swung in the swing region 202. The meniscus is swung based upon the image data (print region 204 of P1) of page P1. For example, the swinging of the meniscus of the nozzles may be based upon image which shows the nozzles to be used for printing after swing region 202 of interleaving region 200. In this manner, a timing of executing swinging may be obtained in swing region 202 which is provided between sheets of paper on page-by-page basis, as one example of “prior to ejecting ink droplets from nozzles (the fourth to n-th columns) used upon printing of the image data (page P1).

In some embodiments, the image data analysis portion 111, the image data processing portion 112, and the selector control portion 113 may serve as one example of the swing control device. In embodiment, a timing of executing swinging may be page printing in progress, as well as, paper interleaving in progress.

In this manner, a timing of executing swinging may vary. For example, a timing of executing swinging may be set so that image data to be first printed is image data targeted to be judged whether or not to execute the swinging. In some embodiments, timing of executing swinging may be set based upon either of paper interleaving or printing which are in progress.

In some embodiments, the “image data to be scheduled to be first printed after swinging of meniscus M” is referred to as image data on a page-by-page basis. Namely, a range targeted for judgment as to whether or not nozzles are used in printing is one page.

In some embodiments, the swing control device may be intended to swing the meniscus of nozzles used in image data of a target unit prior to printing by target units, with two or more given pages serving as the target unit for image analysis. At this time, swinging is not executed as to nozzles which are not used to print image data of the target unit.

For example, if printing of four pages is performed with two pages being a target unit, it is sufficient if: only the meniscus of nozzles used in printing page 1 and 2 is swung prior to printing; pages 1 and 2 are next printed; only the meniscus of nozzles used in printing pages 3 and 4 is then swung; and pages 3 and 4 are further printed.

The present invention is applicable to a variety of image forming apparatuses such as copying machines or facsimile machines, in addition to ink jet printers.

The foregoing techniques which were described in the different embodiments may be appropriately combined with each other.

Having thus described in detail embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. An image forming apparatus, comprising:
a head having:
a plurality of nozzles configured to eject ink for one pixel onto a recording medium;
a plurality of pressurization chambers coupled to the nozzles, respectively, and
wherein the pressurization chambers are configured to hold ink; and
a pressure application portion for executing an ejection operation comprising ejecting the ink from the nozzles by applying a pressure to the ink stored in one of the pressurization chambers and a swinging operation comprising enabling swinging of meniscus of ink in the nozzles, disabling ink ejection;
a print control portion for controlling the ejection operation in the pressure application portion; and
a swing control device for controlling the swing operation in the pressure application portion;
wherein in the swing operation, among the plurality of nozzles, the meniscus of a first nozzle used for printing of image data after the swing operation is enabled to swing before ink is ejected from the first nozzle upon the printing of the image data, and is disabled to swing a meniscus of a second nozzle which is not during printing of the image data.

2. The image forming apparatus according to claim 1, wherein the swing control device controls the swing operation in the pressure application portion to be performed when the image data is not printed.

3. The image forming apparatus according to claim 2, wherein the swing control device controls the swing operation in the pressure application portion to be performed when the image data is printed.

4. The image forming apparatus according to claim 1, wherein the pressure application portion comprises:
a first pressure application portion for executing the ejection operation; and
a second pressure application portion, which is different from the first pressure application portion, for executing the swing operation.

5. The image forming apparatus according to claim 1, wherein the pressure application portion executes the ejection operation and the swing operation by a same member.

6. The image forming apparatus according to claim 1, wherein the image data is comprised of an image to be printed on one page of the recording medium.

7. The image forming apparatus according to claim 1, wherein the image data is comprised of an image of one page obtained by collecting images printed on a plurality of pages of the recording medium.

8. The image forming apparatus according to claim 1, further comprising a transfer portion for transferring the recording medium to the head.

9. An image forming method, comprising:
an ejection step of ejecting ink for one pixel onto recording medium by a plurality of nozzles;
a pressure application step of executing an ejection operation of ejecting the ink from the nozzles by applying a pressure to the ink stored in a respective one of the pressurization chambers and a swinging operation of enabling swinging of meniscus of the ink in the nozzles, disabling ink ejection, in a plurality of pressurization chambers connected with the nozzles, respectively, and accommodate ink therein;
a print control step of controlling the ejection operation in the pressure application step; and
a swing control step of controlling the swing operation in the pressure application step, wherein:
in the swing operation, among the plurality of nozzles, a meniscus of a first nozzle used upon printing of image data to be scheduled to be first printed after the swing operation is enabled to swing before ink is ejected from the first nozzle upon the printing of the image data, and is disabled to swing meniscus of a second nozzle which is not used upon the printing of the image data.

10. A head device, comprising:
a plurality of nozzles which eject ink for one pixel onto recording medium;
a plurality of pressurization chambers connected with the nozzles, respectively, and accommodate ink therein; and
a pressure application portion for executing an ejection operation of ejecting the ink from a first nozzle of the plurality of nozzles by applying a pressure to the ink stored in a respective one of the pressurization chambers and a swinging operation of enabling swinging of a meniscus of the ink in the first nozzle, whereas disabling ink ejection, wherein in the swing operation, among the plurality of nozzles, meniscus of the first nozzle used upon printing of image data to be scheduled to be first printed after the swing operation is enabled to swing before ink is ejected from the first nozzle upon the printing of the image data, and is disabled to swing a meniscus of a second nozzle which is not used upon the printing of the image data.
